(19) United States
(12) Patent Application Publication
(10) Pub. No.: US 2010/0260060 A1
(43) Pub. Date: Oct. 14, 2010

(54) INTEGRATED CALIBRATION PROTOCOL FOR WIRELESS LANS

(75) Inventors: Santosh Abraham, San Diego, CA (US); Sameer Vermani, San Diego, CA (US); Hemanth Sampath, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/754,430

(22) Filed: Apr. 5, 2010

Related U.S. Application Data
(60) Provisional application No. 61/167,785, filed on Apr. 8, 2009.

(51) Int. Cl. H04L 12/26; H04W 4/00

(52) U.S. Cl. 370/252; 370/328

(57) ABSTRACT

Certain aspects of the present disclosure provide a protocol for calibration of an access point in a wireless network.

### CROSS-REFERENCE TO RELATED APPLICATION

This application claims benefit of U.S. provisional application Ser. No. 61/167,785, entitled “INTEGRATED CALIBRATION PROTOCOL FOR WIRELESS LANS”, filed Apr. 8, 2009, which is incorporated herein by reference.

### TECHNICAL FIELD

Certain aspects of the present disclosure generally relate to wireless communication and, more particularly, to a protocol for calibrating an access point.

### BACKGROUND

Spatial Division Multiple Access (SDMA), a communication scheme that allows multiple user terminals communicate with a single base station by sharing the same channel (same time and frequency resources) while achieving high data throughputs, has recently emerged as a popular technique for the next generation of wireless communication systems.

In an SDMA system, a base station (i.e., an access point) may transmit or receive different signals to or from a plurality of mobile user terminals at the same time utilizing the same frequency band. In order to achieve reliable data communication, user terminals may need to be located in sufficiently different directions. Independent signals may be simultaneously transmitted from each of the multiple space-separated antennas to the base station. Consequently, the combined transmissions may be directional, i.e., the signal that is dedicated for each user terminal may be relatively strong in the direction of that particular user terminal and sufficiently weak in directions of other user terminals. Similarly, the base station may simultaneously receive, on the same frequency band, the combined signals from multiple user terminals through each of multiple antennas separated in space, and the combined received signals from the multiple antennas may be split into independent signals transmitted from each user terminal by applying the appropriate signal processing technique.

A multiple-input multiple-output (MIMO) wireless system employs a number (N_{T}) of transmit antennas and a number (N_{R}) of receive antennas for data transmission. A MIMO channel formed by the N_{T} transmit and N_{R} receive antennas may be decomposed into N_{S} spatial streams, where, for all practical purposes, N_{S}=min{N_{T},N_{R}}. The N_{S} spatial streams may be used to transmit N_{S} independent data streams to achieve greater overall throughput.

In a multiple-access MIMO system based on SDMA, an access point can communicate with one or more user terminals at any given moment. If the access point communicates with a single user terminal, then the N_{T} transmit antennas are associated with one transmitting entity (either the access point or the user terminal), and the N_{R} receive antennas are associated with one receiving entity (either the user terminal or the access point). The access point can also communicate with multiple user terminals simultaneously via SDMA. For SDMA, the access point utilizes multiple antennas for data transmission and reception, and each of the user terminals typically utilizes less than the number of access point antennas for data transmission and reception. When SDMA is transmitted from an access point, N_{S}=min {N_{T}, sum(N_{R})}, where sum(N_{R}) represents the summation of all user terminal receive antennas. When SDMA is transmitted to an access point, N_{S}=min {sum(N_{T}), N_{R}}, where sum(N_{T}) represents the summation of all user terminal transmit antennas.

The access point may need to be calibrated while transmitting downlink SDMA data to the user terminals. The calibration process may interrupt the data flow to perform the calibration process. However, there is a need in the art to calibrate the access point without interrupting the SDMA downlink data flow.

### SUMMARY

Certain embodiments provide a method for wireless communications by an access point (AP) for calibration of the AP. The method generally includes transmitting a training request message (TRM) followed by a downlink sounding frame to a station to initiate a calibration procedure, receiving uplink sounding packets and channel state information (CSI) feedback from a station, estimating the uplink channel from the uplink sounding packets, calculating calibration coefficients from the received uplink sounding packets and the CSI feedback message, and applying the calibration coefficients to the channel estimated from the uplink sounding packets to correct the estimated channel.

Certain embodiments provide a method for wireless communications by a station (STA). The method generally includes receiving a training request message (TRM) followed by downlink sounding packets from an access point (AP), calculating channel state information (CSI) from the downlink sounding packets, transmitting uplink sounding packets and the channel state information (CSI) feedback to the AP for calibration, and receiving downlink transmission from the AP that utilizes a calibrated precoding matrix.

Certain embodiments provide an apparatus for wireless communications by an access point (AP) for calibration of the AP. The apparatus generally includes a transmitter configured to transmit a training request message (TRM) followed by a downlink sounding frame to a station to initiate a calibration procedure, a receiver configured to receive uplink sounding packets and channel state information (CSI) feedback from a station, an estimator configured to estimate the uplink channel from the uplink sounding packets, and a calibrator configured to calculate calibration coefficients from the received uplink sounding packets and the CSI feedback message and apply the calibration coefficients to the channel estimated from the uplink sounding packets to correct the estimated channel.

Certain embodiments provide an apparatus for wireless communications by a station (STA). The apparatus generally includes a receiver configured to receive a training request message (TRM) followed by downlink sounding packets from an access point (AP), a calculator configured to calculate channel state information (CSI) from the downlink sounding packets, and a transmitter configured to transmit uplink sounding packets and the channel state information (CSI) feedback to the AP for calibration, wherein the receiver is configured to receive a downlink transmission from the AP utilizing a calibrated precoding matrix.

Certain embodiments provide an apparatus for wireless communications by an access point (AP) for calibration of the AP. The apparatus generally includes means for transmitting a training request message (TRM) followed by a downlink sounding frame to a station to initiate a calibration procedure, means for receiving uplink sounding packets and channel state information (CSI) feedback from a station, means for estimating the uplink channel from the uplink sounding packets, and means for calculating calibration coefficients from the received uplink sounding packets and the CSI feedback message and applying the calibration coefficients to the channel estimated from the uplink sounding packets to correct the estimated channel.

Certain embodiments provide an apparatus for wireless communications by a station (STA). The apparatus generally includes means for receiving a training request message (TRM) followed by downlink sounding packets from an access point (AP), means for calculating channel state information (CSI) from the downlink sounding packets, means for transmitting uplink sounding packets and the channel state information (CSI) feedback to the AP for calibration, and means for receiving a downlink transmission from the AP utilizing a calibrated precoding matrix.

Certain embodiments provide a computer-program product for wireless communications by an access point (AP) for calibration of the AP, comprising a computer-readable medium having instructions stored thereon, the instructions being executable by one or more processors. The instructions generally include instructions for transmitting a training request message (TRM) followed by a downlink sounding frame to a station to initiate a calibration procedure, instructions for receiving uplink sounding packets and channel state information (CSI) feedback from a station, instructions for estimating the uplink channel from the uplink sounding packets, instructions for calculating calibration coefficients from the received uplink sounding packets and the CSI feedback message, and instructions for applying the calibration coefficients to the channel estimated from the uplink sounding packets to correct the estimated channel.

Certain embodiments provide a computer-program product for wireless communications by a station (STA), comprising a computer-readable medium having instructions stored thereon, the instructions being executable by one or more processors. The instructions generally include instructions for receiving a training request message (TRM) followed by downlink sounding packets from an access point (AP), instructions for calculating channel state information (CSI) from the downlink sounding packets, instructions for transmitting uplink sounding packets and the channel state information (CSI) feedback to the AP for calibration, and instructions for receiving downlink transmission from the AP that utilizes a calibrated precoding matrix.

### BRIEF DESCRIPTION OF THE DRAWINGS

So that the manner in which the above recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a spatial division multiple access MIMO wireless system in accordance with certain aspects of the present disclosure.

FIG. 2 illustrates a block diagram of an access point and two user terminals in accordance with certain aspects of the present disclosure.

FIG. 3 illustrates example components of a wireless device in accordance with certain aspects of the present disclosure.

FIG. 4 illustrates an example wireless network for calibrating an access point by utilizing the information received from a station, in accordance with certain aspects of the present disclosure.

FIG. 5 illustrates a calibration procedure based on the institute of electrical and electronics engineers (IEEE) 802.11n standard.

FIG. 6 illustrates example operations for a protocol to calibrate an access point in a wireless network, in accordance with certain aspects of the present disclosure.

FIG. 6A illustrates example components capable of performing the operations shown in FIG. 6.

FIG. 7 illustrates an example downlink integrated calibration procedure for calibrating an access point, in accordance with certain aspects of the present disclosure.

### DETAILED DESCRIPTION

Various aspects of the present disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The word “exemplary” is used herein to mean “serving as an example, instance, or illustration.” Any aspect described herein as “exemplary” is not necessarily to be construed as preferred or advantageous over other aspects. Also as used herein, the term “legacy stations” generally refers to wireless network nodes that support 802.11n or earlier versions of the IEEE 802.11 standard.

The multi-antenna transmission techniques described herein may be used in combination with various wireless technologies such as Code Division Multiple Access (CDMA), Orthogonal Frequency Division Multiplexing (OFDM), Time Division Multiple Access (TDMA), and so on. Multiple user terminals can concurrently transmit/receive data via different (1) orthogonal code channels for CDMA, (2) time slots for TDMA, or (3) sub-bands for OFDM. A CDMA system may implement IS-2000, IS-95, IS-856, Wideband-CDMA (W-CDMA), or some other standards. An OFDM system may implement IEEE 802.11 or some other standards. A TDMA system may implement GSM or some other standards. These various standards are known in the art.

### An Example MIMO System

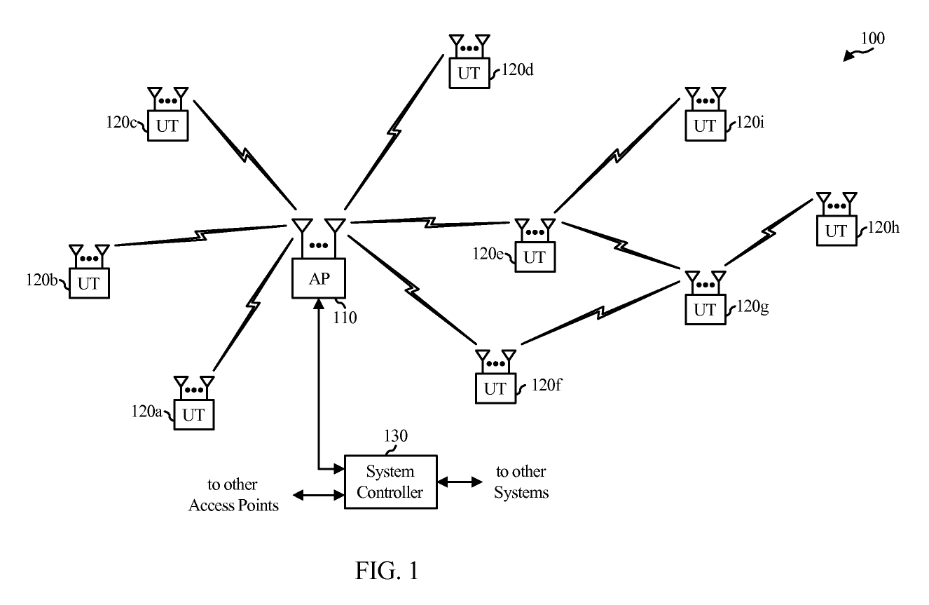

FIG. 1 illustrates a multiple-access MIMO system 100 with access points and user terminals. For simplicity, only one access point 110 is shown in FIG. 1. An access point (AP) is generally a fixed station that communicates with the user terminals and may also be referred to as a base station or some other terminology. A user terminal may be fixed or mobile and may also be referred to as a mobile station, a station (STA), a client, a wireless device, or some other terminology. A user terminal may be a wireless device, such as a cellular phone, a personal digital assistant (PDA), a handheld device, a wireless modem, a laptop computer, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via spatial division multiple access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

System 100 employs multiple transmit and multiple receive antennas for data transmission on the downlink and uplink. Access point 110 is equipped with a number Nₐₚ of antennas and represents the multiple-input (MI) for downlink transmissions and the multiple-output (MO) for uplink transmissions. A set Nᵤ of selected user terminals 120 collectively represents the multiple-output for downlink transmissions and the multiple-input for uplink transmissions. For pure SDMA, it is desired to have Nₐₚ≧Nᵤ≧1 if the data symbol streams for the Nᵤ user terminals are not multiplexed in code, frequency, or time by some means. Nᵤ may be greater than Nₐₚ if the data symbol streams can be multiplexed using different code channels with CDMA, disjoint sets of sub-bands with OFDM, and so on. Each selected user terminal transmits user-specific data to and/or receives user-specific data from the access point. In general, each selected user terminal may be equipped with one or multiple antennas (i.e., Nᵤₜ≧1). The Nᵤ selected user terminals can have the same or different number of antennas.

MIMO system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported).

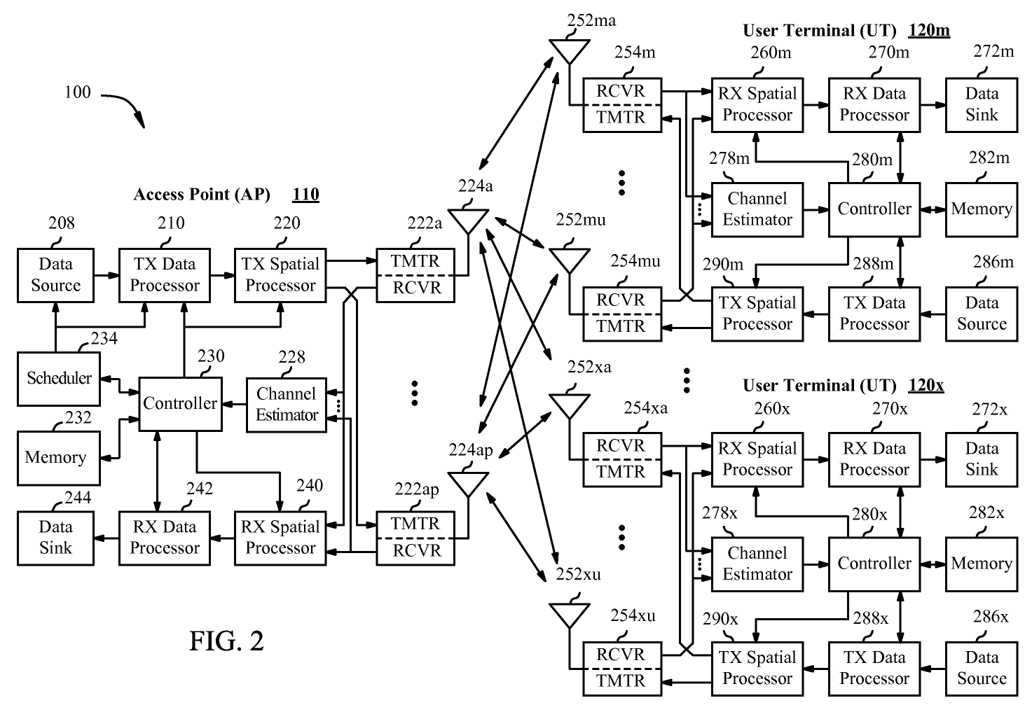

FIG. 2 shows a block diagram of access point 110 and two user terminals 120m and 120x in MIMO system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nₐₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data {d_{up,m}} for the user terminal based on the coding and modulation schemes associated with the rate selected for the user terminal and provides a data symbol stream {s_{up,m}}. A TX spatial processor 290 performs spatial processing on the data symbol stream {s_{up,m}} and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point 110.

A number Nᵤₚ of user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nₐₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), successive interference cancellation (SIC), or some other technique. Each recovered uplink data symbol stream {s_{up,m}} is an estimate of a data symbol stream {s_{up,m}} transmitted by a respective user terminal An RX data processor 242 processes (e.g., demodulates, deinterleaves, and decodes) each recovered uplink data symbol stream {s_{up,m}} in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal TX data processor 210 provides N_{dn} downlink data symbol streams for the N_{dn} user terminals. A TX spatial processor 220 performs spatial processing on the N_{dn} downlink data symbol streams, and provides Nₐₚ transmit symbol streams for the Nₐₚ antennas. Each transmitter unit (TMTR) 222 receives and processes a respective transmit symbol stream to generate a downlink signal. Nₐₚ transmitter units 222 provide Nₐₚ downlink signals for transmission from Nₐₚ antennas 224 to the user terminals.

At each user terminal 120, N_{ut,m} antennas 252 receive the Nₐₚ downlink signals from access point 110. Each receiver unit (RCVR) 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream {s_{dn,m}} for the user terminal. The receiver spatial processing is performed in accordance with the CCMI, MMSE, or some other technique. An RX data processor 270 processes (e.g., demodulates, deinterleaves, and decodes) the recovered downlink data symbol stream to obtain decoded data for the user terminal.

At each user terminal 120, N_{ut,m} antennas 252 receive the Nₐₚ downlink signals from access point 110. Each receiver unit (RCVR) 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream {s_{dn,m}} for the user terminal The receiver spatial processing is performed in accordance with the CCMI, MMSE, or some other technique. An RX data processor 270 processes (e.g., demodulates, deinterleaves, and decodes) the recovered downlink data symbol stream to obtain decoded data for the user terminal.

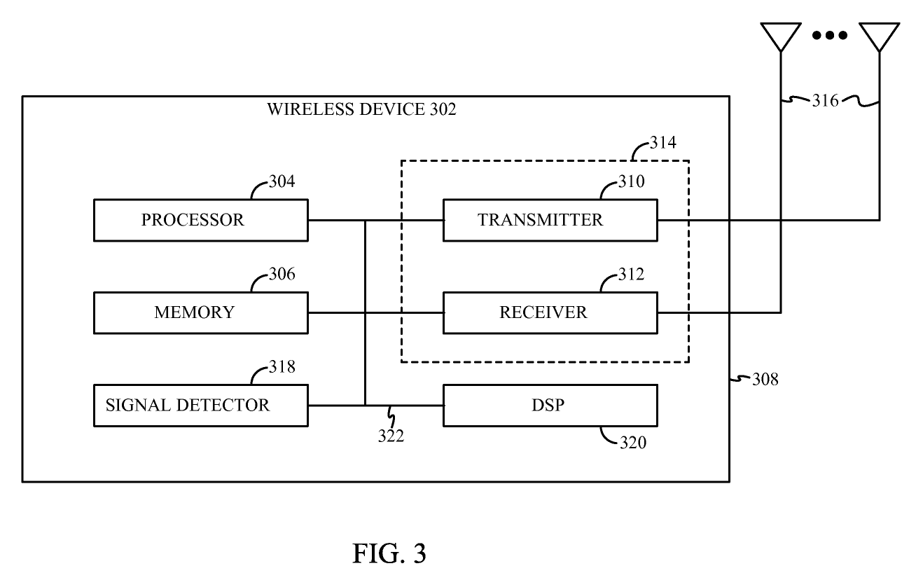

FIG. 3 illustrates various components that may be utilized in a wireless device 302 that may be employed within the system 100. The wireless device 302 is an example of a device that may be configured to implement the various methods described herein. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

As used herein, the term “legacy” generally refers to wireless network nodes that support 802.11n or earlier versions of the 802.11 standard.

While certain techniques are described herein with reference to SDMA, those skilled in the art will recognize the techniques may be generally applied in systems utilizing any type of multiple access schemes, such as SDMA, OFDMA, CDMA, and combinations thereof.

### Integrated Calibration Protocol for Wireless LANS

A protocol for calibrating an access point in a wireless network is presented. The proposed calibration protocol may be utilized while transmitting downlink data to a user terminal without interrupting flow of data from the access point to the user terminal or station (STA).

The following notation is used throughout the present disclosure. N_{AP}^{ANT} represents number of antennas at the AP, N_{STA}^{ANT} represents number of antennas at the STA, H(N_{STA}^{ANT}×N_{AP}^{ANT}) represents the channel between an AP and an STA, H_{STA}^{FL}(N_{STA}^{ANT}×N_{AP}^{ANT}) represents channel estimated at the STA using downlink sounding information sent from the AP, and H_{AP}^{RL}(N_{AP}^{ANT}×N_{STA}^{ANT}) represents the channel estimated at the AP using uplink sounding information sent from the STA.

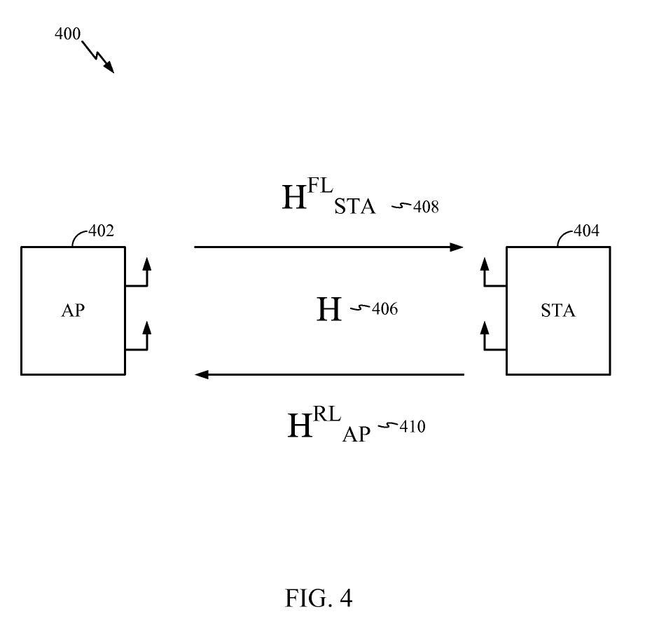

An access point may need to be calibrated for SDMA downlink transmission with implicit channel state information (CSI) feedback. FIG. 4 illustrates an example wireless network in which an access point 402 is calibrated by utilizing information received from a station 404, in accordance with certain aspects of the present disclosure.

The station 404 sends uplink sounding information to the access point 402, from which the AP estimates the channel H 406 between the STA and the AP as H_{AP}^{RL} 410. During calibration process, a correction factor may be obtained for use in adjusting the estimation of the channel from uplink sounding information. The adjusted channel estimate may be used to calculate precoding matrices for the downlink SDMA data transmission.

The AP 402 may transmit downlink sounding information to STA 404, from which the STA may estimate the downlink channel between the AP and the STA (i.e., H_{STA}^{FL} 408). The AP may perform pre-coding on the signals before downlink transmission. In order to accurately pre-code the data, the AP may determine the STA's “view” of the channel H_{STS}^{FL} from the channel estimated from uplink sounding signals (i.e., H_{AP}^{RL}). H_{STA}^{FL} may be written as follows:

H_{STA}^{FL}=K_{STA}^{RX}HK_{AP}^{TX} (1)

where K_{STA}^{RX}(N_{STA}^{ANT}×N_{STA}^{ANT}) is a diagonal matrix representing the receive chain distortion at the STA, and K_{AP}^{TX}(N_{AP}^{ANT}×N_{AP}^{ANT}) is a diagonal matrix representing the transmit chain distortion at the AP.
H_{AP}^{RL} may be written as follows:

H_{AP}^{RL}=K_{AP}^{RX}H^{T}K_{STA}^{TX} (2)

where K_{AP}^{RX}(N_{AP}^{ANT}×N_{AP}^{ANT}) is a diagonal matrix representing the receive chain distortion at the AP, and K_{STA}^{TX}(N_{STA}^{ANT}×N_{STA}^{ANT}) is a diagonal matrix representing the transmit chain distortion at the STA.

Substituting equation (2) in equation (1) results in the following relation between the downlink channel estimate H_{STA}^{FL} and the uplink channel estimate H_{AP}^{RL}:

$${H}_{STA}^{FL} = \underbrace{{{K}_{STA}^{RX} ( {K}_{STA}^{TX} )}^{- 1}}_{{K}_{STA}} {( {H}_{AP}^{RL} )}^{T} \underbrace{{( {K}_{AP}^{RX} )}^{- 1} {K}_{AP}^{TX}}_{{K}_{AP}} \qquad ( 3 )$$

where K_{AP} is a diagonal distortion matrix for the AP, and K_{STA} is the diagonal distortion matrix for the STA. One goal of the calibration process is to estimate the diagonal distortion matrix K_{AP}.

It should be noted that the diagonal distortion matrix for the STA (K_{STA}) does not affect the precoding matrix, because for two downlink channels H₁=H and H₂=DH, where D is a diagonal matrix, the precoding matrices differ only by a scaling factor.

The diagonal matrix K_{AP} may be calculated using the following equations. Assuming C is a matrix whose element Cᵢⱼ is defined as:

$${C}_{ij} = \frac{{H}_{STAij}^{FL}}{{( {H}_{AP}^{RL} )}_{ij}^{T}} , where , \\ i = 1 , 2 , … , {N}_{STA}^{ANT} , and j = 1 , 2 , … , {N}_{AP}^{ANT} \qquad ( 4 )$$

A matrix \tilde{C} may be defined where each row of \tilde{C} is a normalized version of the corresponding row of C, for example:

$$\tilde{C} ( i , : ) = \frac{1}{{C}_{i 1}} C ( i , : ) for i = 1 , 2 , … , {N}_{STA}^{ANT}$$

Through this normalization, we have taken out the dependence of our observations on K_{STA}. Each row of the matrix \tilde{C} serves as a scaled set of observations for the calibration coefficients vector k_{AP} where the scaling is such that the first element of the vector is always one. Since a constant scaling to k_{AP} does not change anything from the calibration point of view, we can use this scaled observation to estimate a scaled version of k_{AP}. Assuming that the columns of \tilde{C} are uncorrelated we can estimate a scaled version of elements of k_{AP} using the columns of \tilde{C}.

Regarding any particular column of \tilde{C}, the observations are coming from different STA antennas and possibly different STAs. Hence each one of these observations can have a different level of accuracy. It may be desirable to give more weight to the observations of the STA antennas who have a better channel. Consequently, the estimate of the j-th element of scaled k_{AP}, may be estimated as the following:

$${( {\hat{k}}_{AP}^{scaled} )}_{j} = \{ \begin{matrix}1 & if j = 1 \\ \frac{{\sum }_{i = 1}^{{N}_{STA}^{ANT}} {\vert {H}_{STAij}^{FL} \vert}^{2} {\tilde{C}}_{ij}}{{\sum }_{i = 1}^{{N}_{STA}^{ANT}} {\vert {H}_{STAij}^{FL} \vert}^{2}} & otherwise\end{matrix}$$

Note that for calibration purposes \hat{k}_{AP}^{scaled} may be used to get to an estimate of the FL channel:

Ĥ_{STA}^{FL}=(H_{AP}^{RL})^{T}·\hat{K}_{AP}^{scaled}

where \hat{K}_{AP}^{scaled} is a diagonal matrix with \hat{k}_{AP}^{scaled} be desirable to maintain a value of each k_{AP} for a multitude of Rx gain states at the AP.

The calibration may be performed with stations that are physically closer to the AP because the channels may be estimated more accurately for these stations. As a result, the calibration coefficients may be more accurate for the closer stations. In addition, for a station close to the AP, the AP can sweep all the receive gain states quickly.

According to certain aspects, an AP may store up-to-date calibration information, for example, in a calibration table. The calibration table may, for example, contain the calibration coefficient k_{AP} for each antenna, each receive gain state and a timeout parameter. Table 1 illustrates an example table format and the type of calibration information that may be contained therein. The calibration coefficient for each antenna may be a complex number selected according to the corresponding gain state.

| Antenna Index | Rx Gain State | K_{AP} | Timeout |
|---|---|---|---|
| 1 | 1 | K_{AP1-1} | 100 ms |
| | 2 | K_{AP1-2} | 100 ms |
| 2 | 1 | K_{AP2-1} | 100 ms |
| | 2 | K_{AP2-2} | 100 ms |

Different protocols may be utilized to perform the communications described above for calibrating the AP. For example, according to certain aspects, such communication may be performed using message formats compliant with or similar to those used in the institute of electrical and electronics engineers (IEEE) 802.11n native protocol. According to certain aspects, such protocols may be used to update the calibration table and may be invoked at association time or at any other time when the calibration coefficients are about to expire.

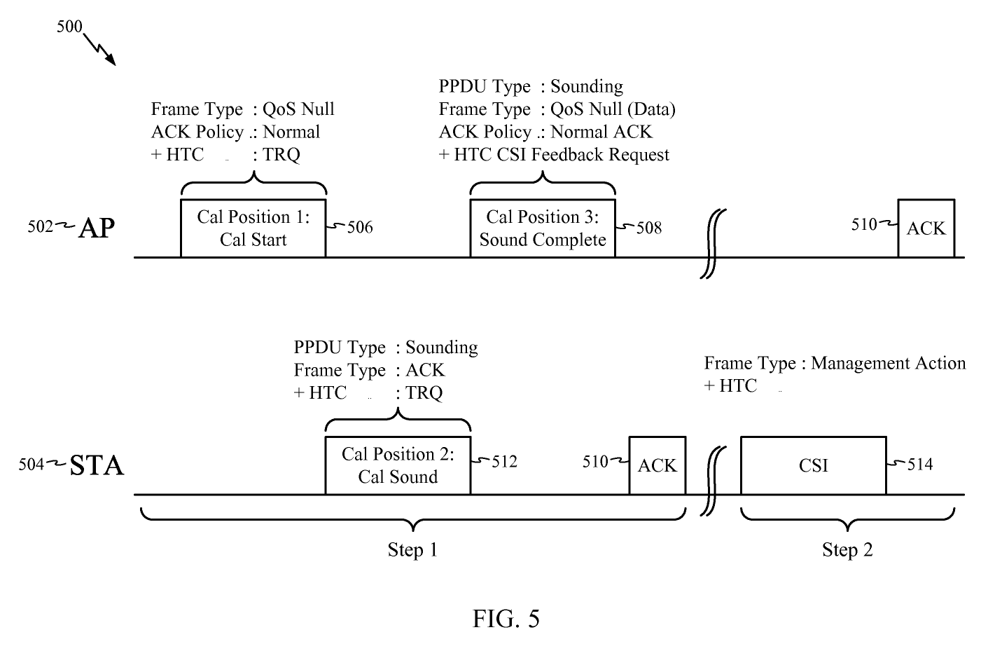

FIG. 5 illustrates an example calibration procedure, that assumes messages based on the IEEE 802.11n standard. As illustrated, an AP 502 may initiate a calibration procedure with a station (STA) 504. The AP 502 may initiate the calibration procedure, for example, by sending a Protocol Data Unit (QoS Null PPDU) message 506. To indicate a start of the calibration procedure, the message 506 may include a High Throughput Control (HTC) field with a calibration position field set to 1.

The message 506 may instruct the STA 504 to send an acknowledgement with training from all the antennas of the STA. As illustrated, the STA may send the ACK as a PPDU message 512 including an HTC field to the AP from each of its antennas. The AP may estimate the channel H_{AP}^{RL} based on the received ACK PPDU messages and send another PPDU message 508 with sounding information from all of its antennas, in which the HTC calibration position field is set to 3 as an indication of the sounding information.

The QoS-NULL PPDU message 508 may signal to the STA that it should send an explicit channel state information (CSI) feedback at a later point in time. The STA 504 may acknowledge reception of the PPDU message 508 with a normal acknowledgement ACK message 510. In addition, the STA may estimate the channel H_{STA}^{FL} from the received information. Once the CSI is calculated, the STA may construct a CSI feedback message 514 and send the CSI feedback message to the AP. Contention may be used at the STA for sending the CSI feedback message 514. The AP may send an ACK message 510 to acknowledge reception of the CSI feedback.

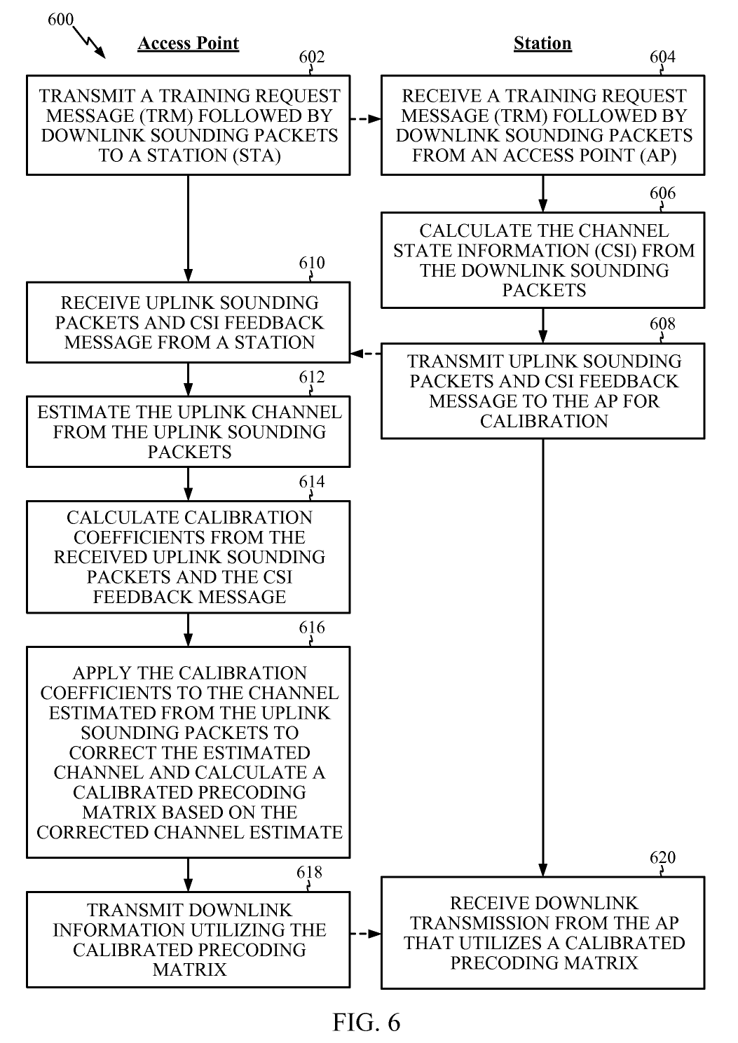

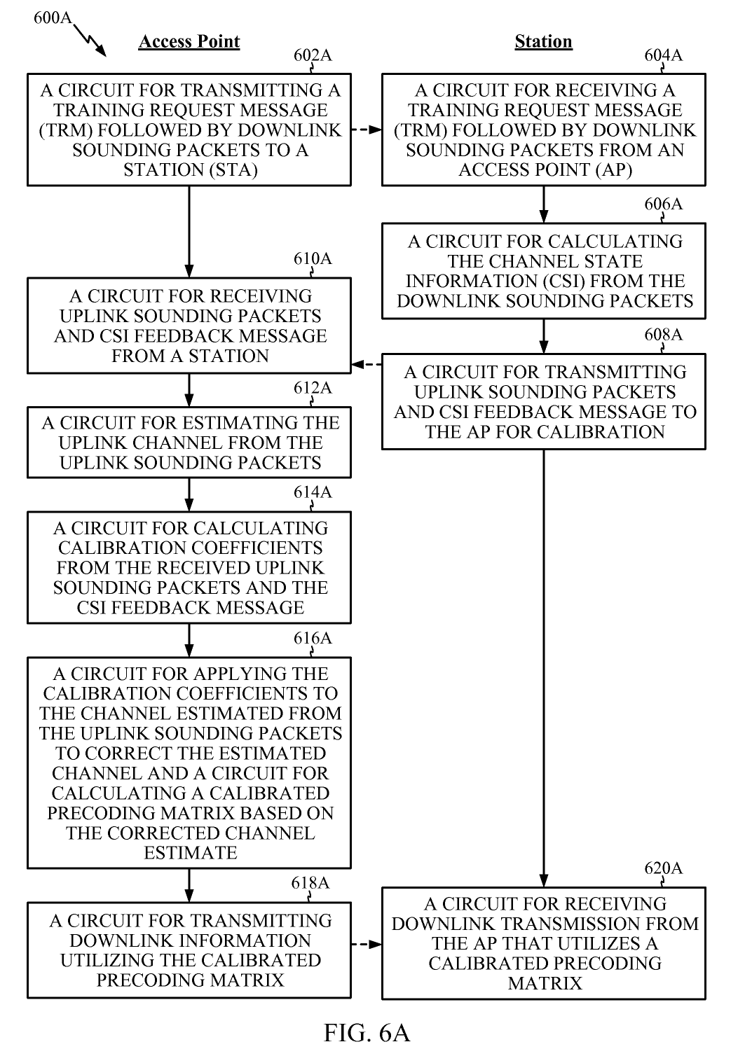

FIG. 6 illustrates example operations for a downlink integrated calibration protocol to calibrate an access point in a wireless network, in accordance with certain aspects of the present disclosure. The operations may corresponding to the exchange of messages in the calibration procedure shown in FIG. 5.

At 602, an AP transmits a training request message (TRM) followed by downlink sounding packets to a station (STA) to initiate a calibration procedure. At 604, the station receives the TRM message and the downlink sounding packets from an access point (AP). At 606, the station calculates the channel state information (CSI) from the downlink sounding packets. At 608, the station transmits uplink sounding packets and channel state information (CSI) feedback to the AP for calibration. At 610, the access point receives uplink sounding packets and channel state information (CSI) feedback from the station.

At 612, the AP estimates the uplink channel from the uplink sounding packets. At 614, the AP calculates calibration coefficients from the received uplink sounding packets and the CSI feedback message. At 616, the AP applies the calibration coefficients to the channel estimated from the uplink sounding packets to correct the estimated channel and calculates a calibrated precoding matrix based on the corrected channel estimate. At 618, the AP transmits downlink information utilizing the calibrated precoding matrix. At 620, the station receives downlink SDMA data transmission from the AP that utilizes a calibrated precoding matrix.

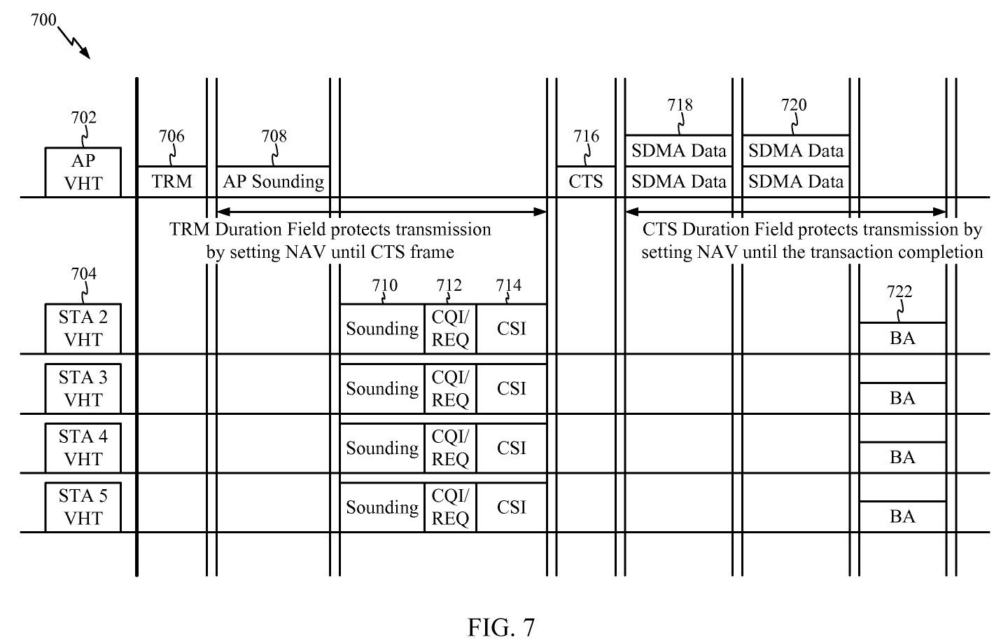

In general, calibration information should be updated periodically to compensate for changes in the channels between the STA and the AP due to thermal changes and other factors. However, if the STAs and APs are involved in a high downlink traffic throughput epoch, it may not be possible to interrupt the data flow to perform calibration without QoS consequences. According to certain aspects of the present disclosure, for high downlink traffic situations, a downlink integrated calibration protocol may be used, for example, that involves packet exchanges illustrated in FIG. 7.

FIG. 7 illustrates an example of a downlink integrated calibration procedure between an AP 702 and a plurality of stations 704 (STA2-STA5), in accordance with certain aspects of the present disclosure. The procedure may be initiated by the AP 702, sending a training request message (TRM) with the calibration bit set to 1. The TRM with the calibration field set to 1 informs the STAs 704 that the TRM will be followed by a downlink sounding frame 708. As illustrated, the TRM may instruct the STAs 704 to send CSI 714 feedback with (piggy-backed to) the sounding frame 710 and channel quality information (CQI) request frame 712.

The AP may calculate calibration coefficients using the received sounding information and the CSI feedback that is sent with the calibration message. The AP may use these calibration coefficients in future SDMA transmissions, for example sending SDMA data 718 and 720 to the STAs 704, following a clear to send (CTS) frame 716. As illustrated, the STAs 704 may respond with block acknowledgement (BA) frame 722.

For certain aspects of the present disclosure, the CSI feedback message may be sent on a subset of frequency tones. This may significantly reduce the size of the message. According to certain aspects, the subset of tones may be standardized in an effort to generate messages with uniform sizes.

The CSI feedback message (714) may be sent on one or a subset of the antennas that are used for transmission of the sounding (710). According to certain aspects, size of the CSI feedback message may be calculated using the following equation:

S_{CSI}=N_{AP}^{ANT}×N_{f}×12+S_{CRC}

where, S_{CSI} represents size of the CSI feedback, N_{AP}^{ANT} represents the number of antennas at the AP, N_{f} represents the number of frequency tones used for the CSI feedback and S_{CRC} represents the size of the CRC message.

As a clarifying example, if the CSI information is sent on 5 frequency tones, in a 16 antenna system, with 32 bits CRC message, number of CSI bits may be calculated as S_{CSI}=5×16×12+32=992 bits. Therefore, the CSI message may be sent in approximately 20 symbols using QPSK modulation. As a result, the calibration may contribute to approximately 176 μs overhead when accounting for the duration of CSI feedback, downlink sounding information, and additional short inter-frame space (SIFS).

While the overhead of the calibration protocol described above may be significant, the calibration procedure may be carried out relatively infrequently, for example, only when needed depending on the expiration time of the calibration coefficients. Thus, the overhead may be acceptable.

For certain aspects of the present disclosure, the downlink integrated calibration protocol may be used to solicit calibration data from a single STA without further downlink data transmission. The downlink integrated calibration protocol may be used with an STA that is located close to the AP. The AP may request the STA to traverse a set of transmit power values to update the calibration coefficients of several receive gain states of the AP.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in Figures, those operations may have corresponding counterpart means-plus-function components with similar numbering. For example, blocks 602-620, illustrated in FIG. 6 correspond to circuit blocks 602A-620A, illustrated in FIG. 6A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by an access point (AP) for calibration of the AP, comprising:
transmitting a training request message (TRM) followed by a downlink sounding frame to a station to initiate a calibration procedure;
receiving uplink sounding packets and channel state information (CSI) feedback from a station;
estimating the uplink channel from the uplink sounding packets;
calculating calibration coefficients from the received uplink sounding packets and the CSI feedback message; and
applying the calibration coefficients to the channel estimated from the uplink sounding packets to correct the estimated channel.

2. The method of claim 1, further comprising:
calculating a calibrated precoding matrix based on the corrected channel estimate; and
performing downlink transmissions utilizing the calibrated precoding matrix.

3. The method of claim 2, wherein the downlink transmissions are sent via a Spatial Division Multiple Access (SDMA) transmission scheme.

4. The method of claim 1, wherein the calibration procedure is performed without interrupting a downlink data transmission.

5. A method for wireless communications by a station (STA), comprising:
receiving a training request message (TRM) followed by downlink sounding packets from an access point (AP);
calculating channel state information (CSI) from the downlink sounding packets;
transmitting uplink sounding packets and the channel state information (CSI) feedback to the AP for calibration; and
receiving downlink transmission from the AP that utilizes a calibrated precoding matrix.

6. The method of claim 5, wherein the CSI feedback is sent on a subset of antennas that are used for transmission of the uplink sounding packets.

7. An apparatus for wireless communications by an access point (AP) for calibration of the AP, comprising:
a transmitter configured to transmit a training request message (TRM) followed by a downlink sounding frame to a station to initiate a calibration procedure;
a receiver configured to receive uplink sounding packets and channel state information (CSI) feedback from a station;
an estimator configured to estimate the uplink channel from the uplink sounding packets; and
a calibrator configured to calculate calibration coefficients from the received uplink sounding packets and the CSI feedback message and apply the calibration coefficients to the channel estimated from the uplink sounding packets to correct the estimated channel.

8. The apparatus of claim 7, wherein:
the calibrator is configured to calculate a calibrated precoding matrix based on the corrected channel estimate; and
the transmitter is configured to perform downlink transmissions utilizing the calibrated precoding matrix.

9. The apparatus of claim 8, wherein the downlink transmissions are sent via a Spatial Division Multiple Access (SDMA) transmission scheme.

10. The apparatus of claim 8, wherein the calibrator is configured to perform a calibration procedure without interrupting a downlink data transmission.

11. An apparatus for wireless communications by a station (STA), comprising:
a receiver configured to receive a training request message (TRM) followed by downlink sounding packets from an access point (AP);
a calculator configured to calculate channel state information (CSI) from the downlink sounding packets; and
a transmitter configured to transmit uplink sounding packets and the channel state information (CSI) feedback to the AP for calibration;
wherein the receiver is configured to receive a downlink transmission from the AP utilizing a calibrated precoding matrix.

12. The apparatus of claim 11, wherein the CSI feedback is sent on a subset of antennas that are used for transmission of the uplink sounding packets.

13. An apparatus for wireless communications by an access point (AP) for calibration of the AP, comprising:
means for transmitting a training request message (TRM) followed by a downlink sounding frame to a station to initiate a calibration procedure;
means for receiving uplink sounding packets and channel state information (CSI) feedback from a station;
means for estimating the uplink channel from the uplink sounding packets; and
means for calculating calibration coefficients from the received uplink sounding packets and the CSI feedback message and applying the calibration coefficients to the channel estimated from the uplink sounding packets to correct the estimated channel.

14. The apparatus of claim 7, wherein:
the means for calculating is configured to calculate a calibrated precoding matrix based on the corrected channel estimate; and
the means for transmitting is configured to perform downlink transmissions utilizing the calibrated precoding matrix.

15. The apparatus of claim 8, wherein the downlink transmissions are sent via a Spatial Division Multiple Access (SDMA) transmission scheme.

16. The apparatus of claim 8, wherein the means for calculating is configured to perform a calibration procedure without interrupting a downlink data transmission.

17. An apparatus for wireless communications by a station (STA), comprising:
means for receiving a training request message (TRM) followed by downlink sounding packets from an access point (AP);
means for calculating channel state information (CSI) from the downlink sounding packets;
means for transmitting uplink sounding packets and the channel state information (CSI) feedback to the AP for calibration; and
means for receiving a downlink transmission from the AP utilizing a calibrated precoding matrix.

18. The apparatus of claim 11, wherein the CSI feedback is sent on a subset of antennas that are used for transmission of the uplink sounding packets.

19. A computer-program product for wireless communications by an access point (AP) for calibration of the AP, comprising a computer-readable medium having instructions stored thereon, the instructions being executable by one or more processors and the instructions comprising:
instructions for transmitting a training request message (TRM) followed by a downlink sounding frame to a station to initiate a calibration procedure;
instructions for receiving uplink sounding packets and channel state information (CSI) feedback from a station;
instructions for estimating the uplink channel from the uplink sounding packets;
instructions for calculating calibration coefficients from the received uplink sounding packets and the CSI feedback message; and
instructions for applying the calibration coefficients to the channel estimated from the uplink sounding packets to correct the estimated channel.

20. The method of claim 19, further comprising:
instructions for calculating a calibrated precoding matrix based on the corrected channel estimate; and
instructions for performing downlink transmissions utilizing the calibrated precoding matrix.

21. The computer-program product of claim 20, wherein the downlink transmissions are sent via a Spatial Division Multiple Access (SDMA) transmission scheme.

22. The computer-program product of claim 19, wherein the calibration procedure is performed without interrupting a downlink data transmission.

23. A computer-program product for wireless communications by a station (STA), comprising a computer-readable medium having instructions stored thereon, the instructions being executable by one or more processors and the instructions comprising:
instructions for receiving a training request message (TRM) followed by downlink sounding packets from an access point (AP);
instructions for calculating channel state information (CSI) from the downlink sounding packets;
instructions for transmitting uplink sounding packets and the channel state information (CSI) feedback to the AP for calibration; and
instructions for receiving downlink transmission from the AP that utilizes a calibrated precoding matrix.

24. The computer-program product of claim 23, wherein the CSI feedback is sent on a subset of antennas that are used for transmission of the uplink sounding packets.
